(19) United States
(12) Patent Application Publication
(10) Pub. No.: US 2009/0213388 A1
(43) Pub. Date: Aug. 27, 2009

(54) MEASUREMENT METHOD AND MEASUREMENT RETICLE

(75) Inventor: Yusuke Matsumura, Utsunomiya-shi (JP)

Correspondence Address: Locke Lord Bissell & Liddell LLP;Attn: IP Docketing, Three World Financial Center, New York, NY, 10281-2101, US

(73) Assignee: CANON KABUSHIKI KAISHA, Tokyo (JP)

(21) Appl. No.: 12/370,381

(22) Filed: Feb. 12, 2009

(30) Foreign Application Priority Data
Feb. 21, 2008 (JP) 2008-040451

(51) Int. Cl. G01B 9/02; G01B 11/00

(52) U.S. Cl. 356/521; 356/401

(57) ABSTRACT

The present invention provides a measurement method of measuring a wavefront aberration of an optical system to be measured, the method including arranging a measurement reticle on an object plane of the optical system to be measured, forming an image of the wavefront measurement mark on an image plane of the optical system to be measured, and calculating the wavefront aberration based on a position shift amount of the image of the wavefront measurement mark from an ideal position, the image being formed on the image plane of the optical system to be measured, wherein the wavefront measurement mark includes a first mark having a longitudinal direction in a first direction, and a second mark having a longitudinal direction in a second direction perpendicular to the first direction and spaced apart from the first mark.

### BACKGROUND OF THE INVENTION

1. Field of the Invention

The present invention relates to a measurement method and a measurement reticle.

2. Description of the Related Art

To manufacture a semiconductor device using photolithography, a projection exposure apparatus is conventionally used, which projects a circuit pattern formed on a reticle (mask) to a wafer or the like via a projection optical system, thereby transferring the circuit pattern.

Along with the recent progress in micropatterning of semiconductor devices, it has become important to accurately manage the optical characteristic of a projection optical system. In particular, it is necessary to accurately measure the wavefront aberration of a projection optical system.

As techniques of measuring the wavefront aberration of a projection optical system, a technique called an ISI method disclosed in U.S. Pat. Nos. 5,828,455 and 5,978,085, and a technique called a SPIN method using a special diffraction grating pattern disclosed in a brochure of International Publication No. 03/088329 are known.

The recent micropatterning of semiconductor devices requires accurate measurement of wavefront aberration including higher-order components. The conventional SPIN method or ISI method cannot always satisfy the required measurement accuracy.

To accurately measure the wavefront aberration of an optical system such as a projection optical system to be measured, including higher-order components, using the SPIN method or ISI method, it is effective to widen the measurement area (target measurement area) on the pupil plane of the optical system to be measured (ideally, make the measurement area closer to the resolution limit of the optical system to be measured).

However, extensive studies by the present inventor have revealed that in the apparatus arrangement of the conventional SPIN method or ISI method, the measurement area on the pupil plane of the optical system to be measured is not wide up to the limit, and there is room to expand the measurement area.

### SUMMARY OF THE INVENTION

The present invention provides a measurement method capable of accurately measuring the wavefront aberration of an optical system to be measured, including higher-order components.

According to the first aspect of the present invention, there is provided a measurement method of measuring a wavefront aberration of an optical system to be measured using a measurement reticle including a wavefront measurement mark and a pinhole to make light from the wavefront measurement mark impinge on different positions on a pupil plane of the optical system to be measured, the method including arranging the measurement reticle on an object plane of the optical system to be measured, forming an image of the wavefront measurement mark on an image plane of the optical system to be measured, and calculating the wavefront aberration of the optical system to be measured based on a position shift amount of the image of the wavefront measurement mark from an ideal position, the image being formed on the image plane of the optical system to be measured, wherein the wavefront measurement mark includes a first mark having a longitudinal direction in a first direction, and a second mark having a longitudinal direction in a second direction perpendicular to the first direction and spaced apart from the first mark.

According to the second aspect of the present invention, there is provided a measurement reticle arranged on an object plane of an optical system to be measured when measuring a wavefront aberration of the optical system to be measured, including a wavefront measurement mark, and a pinhole to make light from the wavefront measurement mark impinge on different positions on a pupil plane of the optical system to be measured, the wavefront measurement mark including a first mark having a longitudinal direction in a first direction, and a second mark having a longitudinal direction in a second direction perpendicular to the first direction and spaced apart from the first mark.

Further features of the present invention will become apparent from the following description of exemplary embodiments with reference to the attached drawings.

### BRIEF DESCRIPTION OF THE DRAWINGS

FIG. 1 is a view showing an example of a wavefront measurement mark (HV mark) used in a measurement apparatus according to an aspect of the present invention.

FIG. 2 is a view showing a wafer on which a reference pattern and a V mark of the wavefront measurement mark shown in FIG. 1 are transferred.

FIG. 3 is a graph showing the relationship between a measurement area and a pinhole diameter when the wavefront aberration of an optical system to be measured is measured using the wavefront measurement mark (HV mark) shown in FIG. 1 (present invention), and the relationship between a measurement area and a pinhole diameter in a box-in-box measurement method.

FIG. 4 is a schematic sectional view showing the arrangement of a measurement apparatus according to an aspect of the present invention.

FIG. 5A is a view showing a wafer on which an H mark and an H mark reference pattern are transferred.

FIG. 5B is a view showing a wafer on which a V mark and a V mark reference pattern are transferred.

FIG. 6 is a view showing the relationship between the H mark and V mark transferred to the wafer and the transfer area (exposure area) on the wafer.

FIGS. 7A and 7B are views showing the relationship between the H mark and V mark transferred to the wafer and the transfer area (exposure area) on the wafer and a given lens image height (x,y).

FIG. 8 is a view for explaining measurement of the position shift amount between the H mark and the H mark reference pattern.

FIG. 9 is a view showing an example of a correction mask to correct the defocus amount difference between the H mark and the V mark transferred to the wafer.

FIG. 10 is a flowchart for explaining correction of the astigmatism error of the wavefront aberration of the optical system to be measured, which is calculated based on the position shift of the H mark and that of the V mark.

FIG. 11 is a flowchart for explaining correction of the astigmatism error of the wavefront aberration of the optical system to be measured, which is calculated based on the position shift of the H mark and that of the V mark.

FIG. 12 is a view showing a mark having a longitudinal direction in a direction perpendicular to the H direction and integrated with the H mark.

FIG. 13 is a flowchart for explaining correction of the astigmatism error of the wavefront aberration of the optical system to be measured, which is calculated based on the position shift of the H mark and that of the V mark.

FIG. 14 is a schematic sectional view showing the arrangement of a measurement apparatus for executing a measurement method according to an aspect of the present invention.

FIG. 15 is a view for explaining the principles of wavefront aberration measurement by a SPIN method.

FIGS. 16A to 16C are views for explaining measurement of the relative position shift between an ideal grating and a diffraction grating pattern formed on a wafer.

FIG. 17 is a view for explaining the principles of wavefront aberration measurement by an ISI method.

FIG. 18 is a graph showing the relationship between a measurement error and a measurement area on the pupil plane of an optical system to be measured.

FIG. 19 is a view showing a wafer on which a diffraction grating pattern and a reference pattern are transferred.

FIG. 20 is a view showing the definitions of the line width of the diffraction grating pattern, the interval between the diffraction grating pattern and the reference pattern, the line width of the reference pattern, the inner width of the reference pattern, and the interval from the resolution limit to the diffraction grating pattern.

FIG. 21 is a schematic sectional view showing the arrangement of an exposure apparatus.

### DESCRIPTION OF THE EMBODIMENTS

A preferred embodiment of the present invention will now be described below with reference to the accompanying drawings. The same reference numerals denote the same members throughout the drawings, and a repetitive description will be omitted.

To foster better understanding of the present invention, first, the principles and detailed problems of wavefront aberration measurement by the SPIN method and ISI method will be explained.

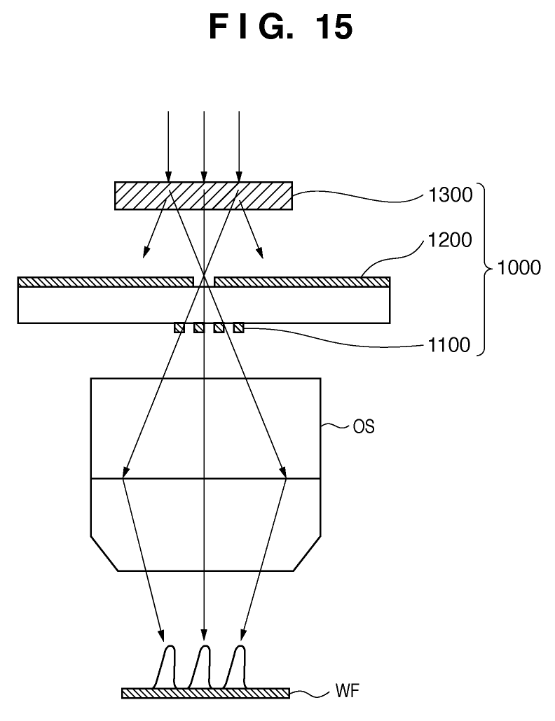

FIG. 15 is a view for explaining the principles of wavefront aberration measurement by the SPIN method. The wavefront aberration measurement by the SPIN method uses a special measurement reticle 1000, as shown in FIG. 15. The measurement reticle 1000 has a wavefront measurement mark 1100 to form a special diffraction grating pattern on the light exit side, and a pinhole 1200 on the light incident side. The measurement reticle 1000 also has a diffusing part 1300 to guide light to the pinhole 1200 at an illumination angle of σ1 or more. FIG. 15 intelligibly illustrates the diffusing part 1300. However, the diffusing part 1300 is actually arranged inside the pinhole 1200.

Light from an illumination system (not shown) reaches the pinhole at σ(σ≧1), that is, at a numerical aperture equal to or larger than that of an optical system OS to be measured to obliquely illuminate the wavefront measurement mark 1100. The wavefront measurement mark 1100 has a function of suppressing generation of diffracted light (e.g., ±1st-order diffracted light) except 0th-order diffracted light by the special diffraction grating pattern. Hence, light components that have passed through points of the diffraction grating pattern of the wavefront measurement mark 1100 arrive at different positions on the pupil plane of the optical system OS to be measured at different angles and then form images on a wafer WF under the influence of the wavefront aberration of the optical system OS to be measured.

The points of the diffraction grating pattern formed on the wafer WF are affected by different wavefront aberrations (phases). Since the light components which have passed through the points of the diffraction grating pattern travel in the normal direction of the wavefront of the optical system OS to be measured, the points of the diffraction grating pattern formed on the wafer WF shift by the tilts of the corresponding points in the pupil plane of the optical system OS to be measured (i.e., shift from ideal positions). As a consequence, when the relative position shift from the reference pattern (an ideal grating that defines an ideal position) of the diffraction grating pattern formed on the wafer WF is measured, the tilt, on the wavefront, of each point in the pupil plane of the optical system OS to be measured is obtained. It is therefore possible to calculate the wavefront aberration based on various mathematical methods.

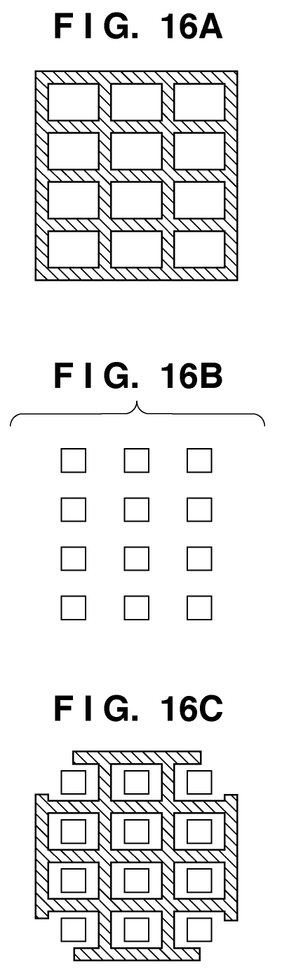

Measurement of the relative position shift between the reference pattern and the diffraction grating pattern formed on the wafer WF will be described with reference to FIGS. 16A to 16C. FIG. 16A shows the diffraction grating pattern (wavefront measurement mark 1100). The diffraction grating pattern is transferred to (printed on) the wafer WF by oblique illumination. FIG. 16B shows the reference pattern. The reference pattern is transferred to (printed on) the wafer WF without using oblique illumination while being overlaid on the diffraction grating pattern shown in FIG. 16A. FIG. 16C shows a result of transfer of the diffraction grating pattern shown in FIG. 16A and the reference pattern shown in FIG. 16B to the wafer WF. The corner parts of the diffraction grating pattern do not resolve in FIG. 16C because of the influence of an aperture stop arranged on the pupil plane of the optical system OS to be measured.

As shown in FIG. 16C, when the diffraction grating pattern and the reference pattern are transferred to the wafer, an overlay measurement apparatus measures the relative position shift between the diffraction grating pattern and the reference pattern. More specifically, the relative position shift between the center of a box of the reference pattern and the center of a box of the diffraction grating pattern that surrounds the box of the reference pattern is measured (this is called a “box-in-box measurement method”). A point (measurement point) where the relative position shift should be measured is set at the center of each box of the reference pattern.

As described above, in the SPIN method, normally, a special diffraction grating pattern is transferred to a wafer as a wavefront measurement mark. The position shift of the diffraction grating pattern is measured by the box-in-box measurement method, thereby measuring the wavefront aberration of the optical system to be measured.

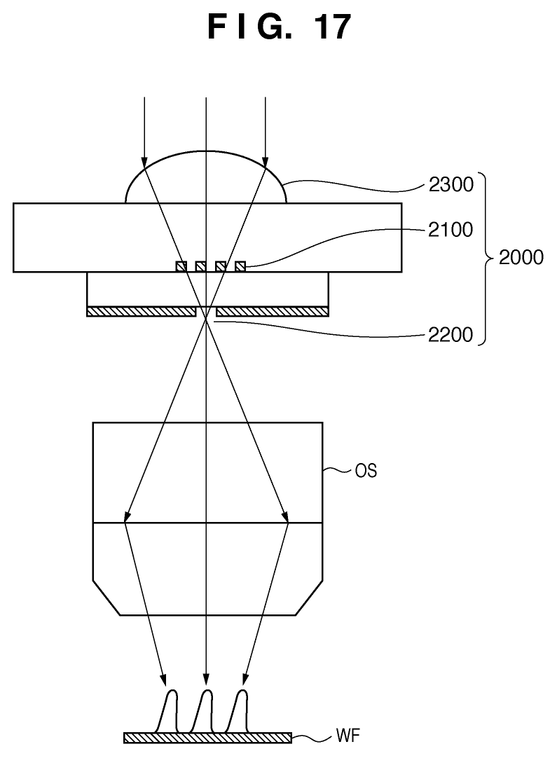

FIG. 17 is a view for explaining the principles of wavefront aberration measurement by the ISI method. The wavefront aberration measurement by the ISI method uses a special measurement reticle 2000, as shown in FIG. 17. The measurement reticle 2000 has a lattice-shaped wavefront measurement mark 2100, a pinhole 2200 arranged under the center of the wavefront measurement mark 2100 at a predetermined distance, and a convex lens (positive lens) 2300 arranged just above the wavefront measurement mark 2100.

Light from an illumination system (not shown) illuminates the wavefront measurement mark 2100 at an illumination angle of σ1 or more via the convex lens 2300. The light which has passed through the diffraction grating pattern included in the wavefront measurement mark 2100 passes through the pinhole 2200. However, the light capable of passing through the pinhole 2200 includes only light components having angles to connect the pinhole 2200 and the positions of points of the diffraction grating pattern. Hence, the light components that have passed through the points of the diffraction grating pattern of the wavefront measurement mark 2100 arrive at different positions on the pupil plane of the optical system OS to be measured at different angles and then form an image on the wafer WF under the influence of the wavefront aberration of the optical system OS to be measured.

The points of the diffraction grating pattern formed on the wafer WF are affected by different wavefront aberrations (phases). Since the light components which have passed through the points of the diffraction grating pattern travel in the normal direction of the wavefront of the optical system OS to be measured, the points of the diffraction grating pattern formed on the wafer WF shift by the tilts, on the wavefront, of the corresponding points in the pupil plane of the optical system OS to be measured (i.e., shift from ideal positions). As a consequence, when the relative position shift from the reference pattern (an ideal grating that defines an ideal position) of the diffraction grating pattern formed on the wafer WF is measured, the tilt, on the wavefront, of each point in the pupil plane of the optical system OS to be measured is obtained. It is therefore possible to calculate the wavefront aberration based on various mathematical methods.

In the ISI method as well, the relative position shift between the diffraction grating pattern and the reference pattern is measured by the box-in-box measurement method, thereby measuring the wavefront aberration of the optical system to be measured, as in the SPIN method.

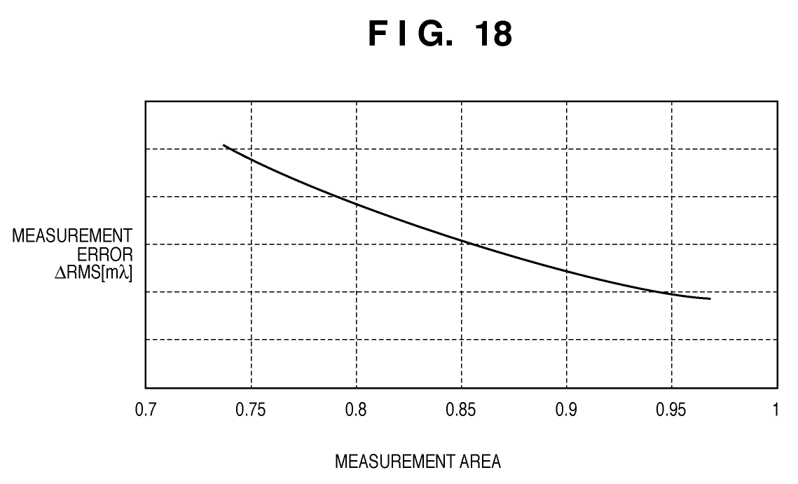

The position shift amount (measured value) of the diffraction grating pattern in the SPIN method and ISI method reflects the tilt of the wavefront of the optical system to be measured, as described above. The tilt of the wavefront of the optical system to be measured becomes large near the pupil plane for a higher-order component. Hence, to accurately measure the wavefront aberration including higher-order components, it is necessary to set the measurement area (target measurement area) on the pupil plane of the optical system such as a projection optical system to be measured to the vicinity of the pupil plane. In other words, it is possible to increase the wavefront aberration measurement accuracy by expanding the measurement area on the pupil plane of the optical system to be measured, as shown in FIG. 18 (that is, it is possible to accurately measure the wavefront aberration including higher-order components). FIG. 18 is a graph showing the relationship between a measurement error and the measurement area on the pupil plane of the optical system to be measured. In FIG. 18, the abscissa represents a value obtained by normalizing the radius of the measurement area on the pupil plane of the optical system to be measured by the numerical aperture (NA) of the optical system to be measured. The ordinate represents the RMS value (the integral value of the square of the wavefront aberration on the pupil plane) of the measurement error of 36 Zernike terms.

The measurement area on the pupil plane of the optical system to be measured becomes smaller than the full NA (σr=1) of the optical system to be measured such as a projection optical system due to the following two factors. The first factor is that the diffraction grating pattern does not resolve up to σr=1. Note that σr at the limit of resolution of the diffraction grating pattern will be referred to as a resolution limit hereinafter. As the second factor, the measurement area becomes smaller than the above-described resolution limit when measuring the position shift of the diffraction grating pattern using the box-in-box measurement method.

The first factor (the reason why the resolution limit becomes smaller than σr=1) will be described.

In the SPIN method, the pinhole has a function of obliquely illuminating the diffraction grating pattern with only light components having angles to connect the pinhole and the points of the diffraction grating pattern. The light which has passed through the pinhole passes through a finite area of the diffraction grating pattern. The diffraction grating pattern has a function of suppressing generation of diffracted light except 0th-order diffracted light, as described above. For this reason, the light components that have passed through the points of the diffraction grating pattern include only 0th-order diffracted light. Hence, diffracted light from the diffraction grating pattern passes through the pupil plane of the optical system to be measured in a finite size. In other words, the diameter of the pinhole is equivalent to the diameter of the light beam on the pupil plane of the optical system to be measured. Since the diameter of the light beam is finite, some light components cannot pass through the diffraction grating pattern near the pupil plane of the optical system to be measured due to the aperture stop. As a result, light components which have passed through the peripheral portion close to the outer edge of the pupil plane of the optical system to be measured do not resolve on the wafer at all or incompletely resolve. Hence, the (size of the) measurement area on the pupil plane of the optical system to be measured is affected by the pinhole diameter, that is, the aperture diameter. More specifically, letting σs be the pinhole diameter on the pupil plane of the optical system to be measured, the resolution limit at which the diffraction grating pattern completely resolves, that is, the diameter of the measurement area on the pupil plane of the optical system to be measured is σr=1−σs. Note that σs and σr are values obtained by normalizing the radius by the full NA of the optical system to be measured. Actually, resolution of the diffraction grating pattern does not abruptly stop at σr=1−σs. However, setting an area outside σr=1−σs as a measurement point (measurement area) causes a measurement error. An example in which only measurement points in the measurement area of σr=1−σs are used will be examined below. This value is defined as the resolution limit.

In the ISI method, the pinhole has a function of passing, of the diffracted light from the diffraction grating pattern, only light components having angles to connect the pinhole and the points of the diffraction grating pattern. In other words, the pinhole mechanically shields the diffracted light from the diffraction grating pattern. The diffracted light from the diffraction grating pattern, which has passed through the pinhole, passes through the pupil plane of the optical system to be measured in a finite size. The diameter of the pinhole is equivalent to the diameter of the light beam on the pupil plane of the optical system to be measured. Hence, there is a resolution limit (σr=1−σs), as in the SPIN method.

As described above, in the SPIN method and ISI method, the limit value the measurement area can take is σr=1−σs, which is smaller than the full NA (σr=1) of the optical system to be measured.

The second factor (the reason why the measurement area becomes smaller than the resolution limit when measuring the position shift of the diffraction grating pattern using the box-in-box measurement method) will be described.

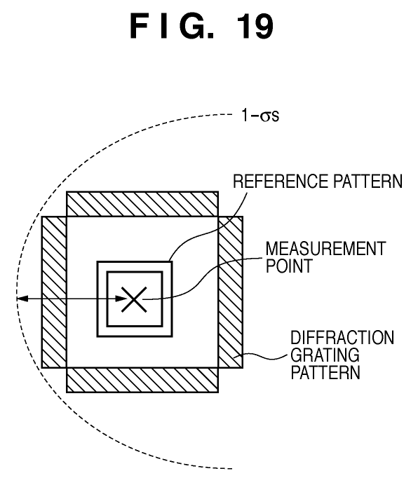

FIG. 19 is a view showing a wafer on which a diffraction grating pattern and a reference pattern are transferred. The dotted line indicates the resolution limit (1−σs). As is apparent from FIG. 19, the measurement point to measure the wavefront of the optical system to be measured exists inside the dotted line representing the resolution limit. This is because the conventional SPIN method and ISI method execute the box-in-box measurement method, that is, measure the relative position shift between the diffraction grating pattern and the reference pattern (two box patterns) as the position shift of one measurement point. To measure the position shift of a measurement point, all the four sides of the diffraction grating pattern which surround the measurement point must have resolved. Consequently, the measurement area becomes smaller than the resolution limit by the size of the diffraction grating pattern.

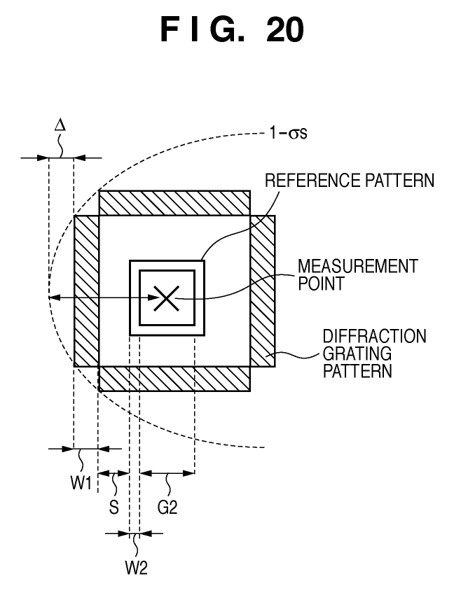

For example, as shown in FIG. 20, let W1 be the line width of the diffraction grating pattern, S be the interval between the diffraction grating pattern and the reference pattern, W2 be the line width of the reference pattern, G2 be the inner width (the interval between the lines) of the reference pattern, and A be the interval from the resolution limit (σr=1−σs) to the diffraction grating pattern. These values are obtained by normalizing values on the pupil plane of the optical system to be measured by the full NA of the optical system to be measured. Referring to FIG. 20, the radius of the measurement area on the pupil plane of the optical system to be measured is 1−σs−(W1+S+W2+G2/2+Δ), which is smaller than the resolution limit. FIG. 20 is a view showing the definitions of the line width of the diffraction grating pattern, the interval between the diffraction grating pattern and the reference pattern, the line width of the reference pattern, the inner width of the reference pattern, and the interval from the resolution limit to the diffraction grating pattern in FIG. 19.

As described above, to accurately measure the wavefront aberration of an optical system such as a projection optical system to be measured, including higher-order components, using the SPIN method or ISI method, it is necessary to widen the measurement area on the pupil plane of the optical system to be measured (ideally, make the measurement area closer to the resolution limit of the optical system to be measured).

For this purpose, in the present invention, two independent first and second marks which are arranged in correspondence with each point of the pupil plane of the optical system to be measured and are perpendicular to each other, are used as a wavefront measurement mark. The position shift amount of the first mark image formed on the image plane of the optical system to be measured from an ideal position and the position shift amount of the second mark image from an ideal position are measured. Wavefront aberrations calculated based on the two position shift amounts are combined, thereby measuring the wavefront aberration of the optical system to be measured. This allows expanding the measurement area on the pupil plane of the optical system such as a projection optical system to be measured and improve the wavefront aberration measurement accuracy (i.e., enables accurate measurement of the wavefront aberration including higher-order components)

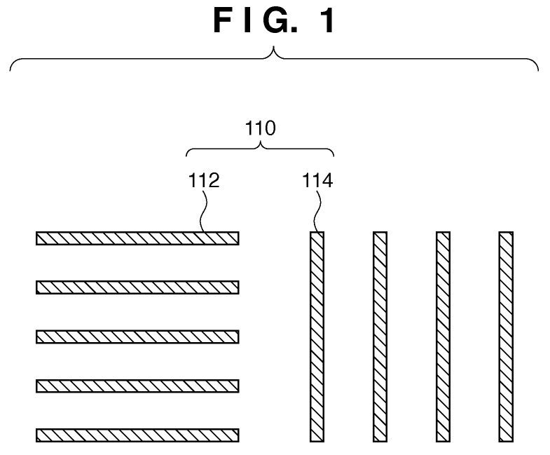

More specifically, as shown in FIG. 1, a wavefront measurement mark 110 including a first mark (to be referred to as an “H mark” hereinafter) 112 and a second mark (to be referred to as a “V mark” hereinafter) 114 is used. The H mark 112 is formed to have a longitudinal direction in the first direction. The V mark 114 is spaced apart from the H mark 112 and has a longitudinal direction in the second direction perpendicular to the first direction. The H mark 112 and V mark 114 will collectively be referred to as an HV mark hereinafter. The H mark 112 and V mark 114 are transferred to a wafer at different positions. After that, a reference pattern parallel to the H mark 112 is transferred to the wafer while being overlaid on the H mark 112. A reference pattern parallel to the V mark 114 is transferred to the wafer while being overlaid on the V mark 114. The relative position shift between the H mark 112 and the reference pattern and that between the V mark 114 and the reference pattern are then measured.

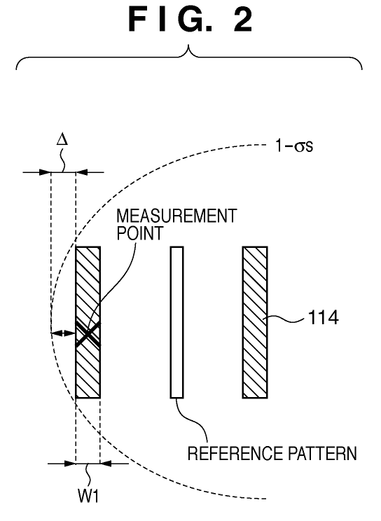

FIG. 2 is a view showing a wafer on which a reference pattern and the V mark 114 are transferred. The dotted line indicates the resolution limit (1−σs). As shown in FIG. 2, in the present invention, it is possible to set a point (measurement point) where the relative position shift should be measured on the V mark 114 (i.e., measure the position shift on the V mark 114) and expand the measurement area. For example, let W1 be the line width of the V mark 114, and Δ be the interval from the resolution limit (σr=1−σs) to the V mark 114. At this time, the radius of the measurement area on the pupil plane of the optical system to be measured is 1−σs−(W1/2+Δ). Hence, the measurement area in the present invention is wider than that in the box-in-box measurement method, and the wavefront aberration measurement accuracy can be increased.

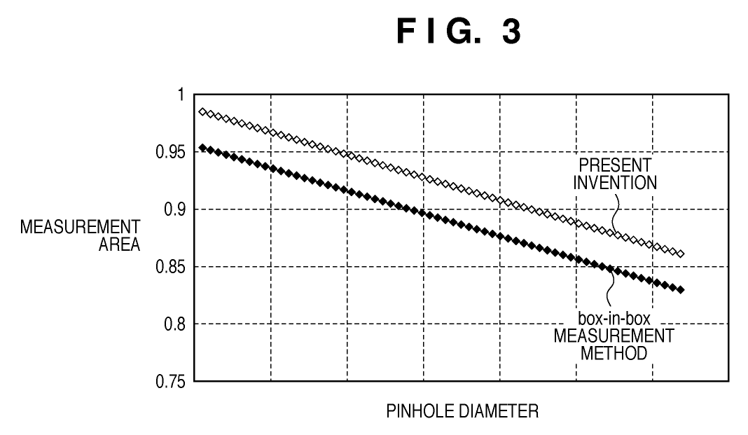

FIG. 3 is a graph showing the relationship between the measurement area and the pinhole diameter when the wavefront aberration of the optical system to be measured is measured using the wavefront measurement mark 110 (HV mark) (present invention), and the relationship between the measurement area and the pinhole diameter in the box-in-box measurement method. As is apparent from FIG. 3, if the pinhole diameter is the same, the measurement area on the pupil plane of the optical system to be measured can be made wider using the wavefront measurement mark 110 (HV mark) than that in the box-in-box measurement method.

Even when the diffraction grating pattern shown in FIG. 16A is used, the measurement area can be made wider, as in use of the HV mark, by separately measuring the pattern having the longitudinal direction in the first direction and the pattern having the longitudinal direction in the second direction. However, the wavefront measurement mark 110 (HV mark) shown in FIG. 1 is more advantageous than the diffraction grating pattern shown in FIG. 16A in two points to be described below.

The first point is the number of measurement points in the measurement area. When the diffraction grating pattern shown in FIG. 16A is used, the size of the reference pattern is larger than its line width. This is because to measure the position shifts in both the first and second directions using one reference pattern, the reference pattern need to have the longitudinal direction in the first and second directions.

On the other hand, when the H mark 112 is used, only the position shift in the second direction is measured. The reference pattern needs to have the longitudinal direction in the first direction. In this case, the size of the reference pattern equals its line width. Hence, the number of measurement points can be larger when the wavefront measurement mark 110 (HV mark) shown in FIG. 1 is used than when the diffraction grating pattern shown in FIG. 16A is used. It is therefore possible to increase the wavefront aberration measurement accuracy.

The second point is the direction of the wavefront aberration at each measurement point. When the diffraction grating pattern shown in FIG. 16A is used, only the position shift in the first or second direction can be measured at each measurement point. Hence, only wavefront aberration (wavefront aberration information) in one direction can be obtained at each measurement point on the pupil plane of the optical system to be measured. As a result, wavefront aberration calculation processing after position shift measurement becomes complex.

Even when the wavefront measurement mark 110 (HV mark) shown in FIG. 1 is used, only the position shift in the first or second direction can be measured at each measurement point. However, since the H mark 112 and V mark 114 are transferred, the measurement results (i.e., position shifts) of the two marks can be combined. It is therefore possible to obtain wavefront aberrations (wavefront aberration information) in both the first and second directions at each measurement point on the pupil plane of the optical system to be measured. As a result, wavefront aberration calculation processing after position shift measurement is simplified.

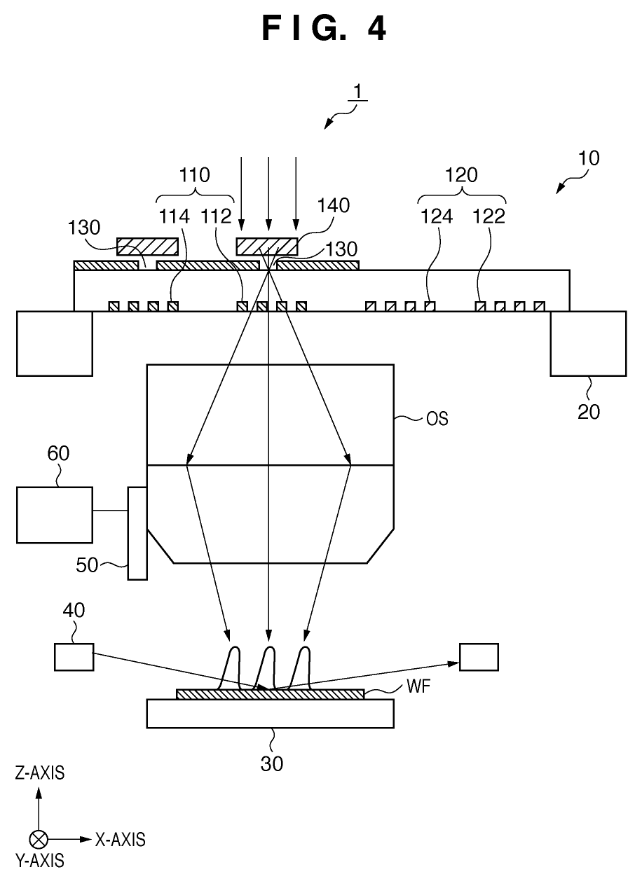

A method of measuring the wavefront aberration of the optical system to be measured using the wavefront measurement mark 110 (HV mark) shown in FIG. 1 will be described below. FIG. 4 is a schematic sectional view showing the arrangement of a measurement apparatus 1 for executing the measurement method according to an aspect of the present invention.

The measurement apparatus 1 measures the wavefront aberration of the optical system OS (e.g., the projection optical system of an exposure apparatus) to be measured using the SPIN method. The measurement apparatus 1 includes an illumination system (not shown), a measurement reticle 10 arranged on the object plane of the optical system OS to be measured, a reticle stage 20, a wafer stage 30, an auto-focus system 40, an alignment scope 50, and a calculation unit 60.

The measurement reticle 10 is placed on the reticle stage 20 via a reticle chuck (not shown) and supported to be drivable in the X-, Y-, and Z-axis directions. The measurement reticle 10 has the wavefront measurement mark 110 including the H mark 112 and V mark 114 shown in FIG. 1 on the light exit side. The H mark 112 and V mark 114 are two independent marks which are perpendicular to each other, as described above. In other words, the H mark 112 and V mark 114 are spaced apart from each other. Note that each of the H mark 112 and V mark 114 is formed from a special diffraction grating pattern for suppressing generation of diffracted light except 0th-order diffracted light.

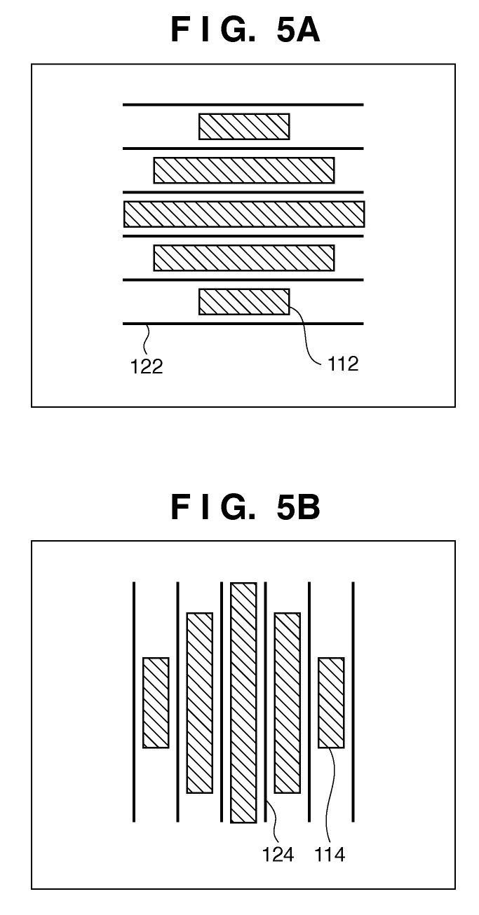

The measurement reticle 10 also has a reference pattern 120 for the H mark 112 and V mark 114 on the light exit side. The reference pattern 120 includes different reference patterns for the H mark 112 and V mark 114. In this embodiment, the reference pattern 120 includes an H mark reference pattern 122 as a reference pattern for the H mark 112, and a V mark reference pattern 124 as a reference pattern for the V mark 114. The H mark reference pattern is a line pattern parallel to the H mark 112. The elements of the H mark reference pattern 122 have such an interval that they are transferred to the wafer WF between the elements of the H mark 112, as shown in FIG. 5A. The V mark reference pattern 124 is a line pattern parallel to the V mark 114. The elements of the V mark reference pattern 124 have such an interval that they are transferred to the wafer WF between the elements of the V mark 114, as shown in FIG. 5B. FIG. 5A is a view showing the wafer WF on which the H mark 112 and the H mark reference pattern are transferred. FIG. 5B is a view showing the wafer WF on which the V mark 114 and the V mark reference pattern are transferred. The H mark 112 and V mark 114 are transferred in a circular shape in FIGS. 5A and 5B because of an aperture stop arranged on the pupil plane of the optical system OS to be measured.

The measurement reticle 10 also has pinholes 130 corresponding to the H mark 112 and V mark 114 on the light incident side. The pinholes 130 have a function of making light from the wavefront measurement mark 110 (H mark 112 and V mark 114) impinge on different positions on the pupil plane of the optical system OS to be measured. Each of the pinholes 130 has a diffusing part 140 to uniformly illuminate the entire surface of the H mark 112 or V mark with the light which has passed through the pinhole 130. The diffusing part 140 is formed from, for example, a diffuser, computer generated hologram (CGH), or diffraction optical element. FIG. 4 intelligibly illustrates the diffusing part 140. However, the diffusing part 140 is actually arranged inside the pinhole 130.

The measurement reticle 10 has no pinhole but an opening on the light incident side in correspondence with the reference pattern 120. Hence, the reference pattern 120 is not obliquely but normally illuminated and transferred to the wafer WF. The size of the opening provided in correspondence with the reference pattern 120 is preferably almost equal to the NA of the optical system OS to be measured.

The operation of the measurement apparatus 1, that is, measurement of the wavefront aberration of the optical system OS to be measured by the measurement apparatus 1 will be described.

Light from the illumination system (not shown) illuminates the wavefront measurement mark 110 (H mark 112 and V mark 114) of the measurement reticle 10. At this time, an illumination area adjusting mechanism (e.g., masking blade) (not shown) provided in the illumination system is driven to locate the H mark 112 and V mark 114 simultaneously in the illumination area. Next, the focus position (Z-axis position) of the wafer WF is detected using the auto-focus system 40. The wafer stage 30 is driven in the Z-axis direction based on the detection result to arrange the wafer WF near the best focus plane of the optical system OS to be measured. The reticle stage 20 and the wafer stage 30 are scanned at a speed ratio corresponding to the reduction ratio of the optical system OS to be measured, thereby transferring the H mark 112 and V mark 114 to the wafer WF simultaneously (i.e., in one exposure step).

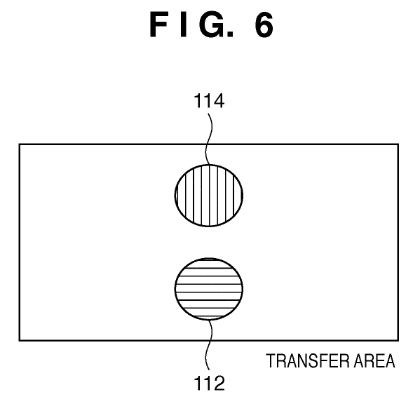

FIG. 6 is a view showing the relationship between the H mark 112 and V mark 114 transferred to the wafer WF and the transfer area (exposure area) on the wafer WF. There are the following three characteristic features in simultaneously transferring the H mark 112 and V mark 114. As the first characteristic feature, an error is generated because of the difference in the position (lens image height) between the H mark 112 and the V mark 114 in the transfer area. As the second characteristic feature, simultaneous transfer of the H mark 112 and V mark 114 is not affected by the focus driving error of the wafer WF (i.e., the driving reproducibility of the wafer WF). As the third characteristic feature, simultaneous transfer of the H mark 112 and V mark 114 is affected by the flatness of the wafer WF.

Note that the H mark 112 and V mark 114 may separately be transferred to the wafer WF. First, the illumination area adjusting mechanism (not shown) provided in the illumination system is driven to locate only the H mark 112 of the wavefront measurement mark 110 of the measurement reticle 10 in the illumination area (i.e., a predetermined position on the object plane of the optical system OS to be measured). Next, the focus position (Z-axis position) of the wafer WF is detected using the auto-focus system 40. The wafer stage 30 is driven in the Z-axis direction based on the detection result to arrange the wafer WF near the best focus plane of the optical system OS to be measured. The reticle stage 20 and the wafer stage 30 are scanned at a speed ratio corresponding to the reduction ratio of the optical system OS to be measured, thereby transferring only the H mark 112 to the wafer WF in the first exposure step. Then, in the same way (by, e.g., driving the illumination area adjusting mechanism (not shown) provided in the illumination system to locate only the V mark 114 of the wavefront measurement mark 110 of the measurement reticle 10 in the illumination area), only the V mark 114 is transferred to the wafer WF in the second exposure step. However, the V mark 114 is transferred using the same lens image height as that when transferring the H mark 112. Note that the H mark 112 and V mark 114 can be transferred in an arbitrary order. One of the H mark 112 and V mark 114 is transferred in the first exposure step, and the other of the H mark 112 and V mark 114 is transferred in the second exposure step.

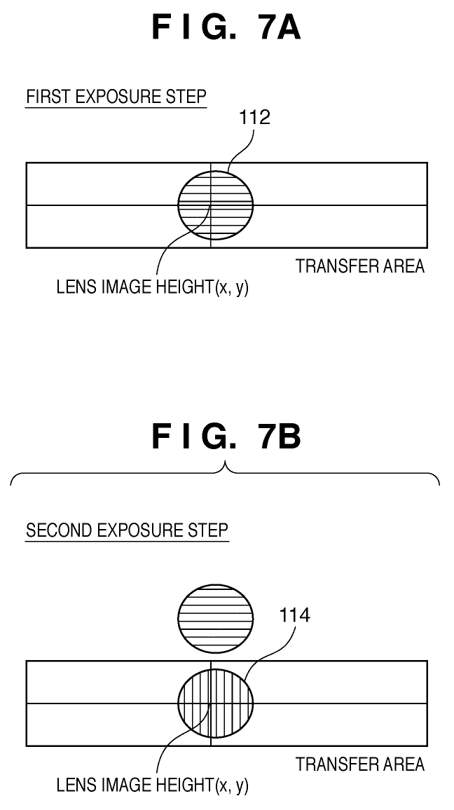

FIGS. 7A and 7B are views showing the relationship between the H mark 112 and V mark 114 transferred to the wafer WF and the transfer area (exposure area) on the wafer WF and a given lens image height (x,y). FIG. 7A shows a state in the first exposure step. FIG. 7B shows a state in the second exposure step. FIGS. 7A and 7B illustrate an example in which the lens image height (x,y) matches the center of the H mark 112 or V mark 114 in each exposure step. There are the following three characteristic features in separately transferring the H mark 112 and V mark 114. As the first characteristic feature, the lens image height when transferring the H mark 112 can be made almost the same as that when transferring the V mark 114 in the transfer area. As the second characteristic feature, separate transfer of the H mark 112 and V mark 114 is affected by the focus driving error of the wafer WF (i.e., the driving reproducibility of the wafer WF). As the third characteristic feature, separate transfer of the H mark 112 and V mark 114 is not affected by the flatness of the wafer WF.

The error component that generates the defocus difference (i.e., the difference in the defocus amount between the image of the H mark 112 and that of the V mark 114) between the H mark 112 and the V mark 114 changes between the simultaneous transfer of the H mark 112 and V mark 114 and the separate transfer of the H mark 112 and V mark 114. In the simultaneous transfer of the H mark 112 and V mark 114, after the focus position of the wafer WF is adjusted to the best focus plane of the optical system OS to be measured, the H mark 112 and V mark 114 are transferred. Hence, the flatness of the wafer WF is the major factor of the defocus difference between the H mark 112 and the V mark 114. On the other hand, in the separate transfer of the H mark 112 and V mark 114, the focus position of the wafer WF is adjusted to the best focus plane of the optical system OS to be measured in each of transfer of the H mark 112 and transfer of the V mark 114. Hence, the focus driving error of the wafer WF is the major factor of the defocus difference between the H mark 112 and the V mark 114.

Correction of the defocus difference between the H mark 112 and the V mark 114 (the difference in the defocus amount between the image of the H mark 112 and that of the V mark 114) will be described later in detail. For the correction, however, it is necessary to select whether to simultaneously transfer the H mark 112 and V mark 114 or separately transfer them.

When the H mark 112 and V mark 114 are thus transferred to the wafer WF, the reticle stage 20 is driven to locate the H mark reference pattern 122 in the illumination area. The H mark reference pattern 122 is transferred such that it is overlaid on the H mark 112 transferred to the wafer WF (FIG. 5A). Similarly, the V mark reference pattern 124 is transferred such that it is overlaid on the V mark 114 transferred to the wafer WF (FIG. 5B). Note that the H mark reference pattern 122 and V mark reference pattern 124 can be transferred either simultaneously or separately. The H mark reference pattern 122 and V mark reference pattern 124 can be transferred in an arbitrary order.

When the H mark 112, V mark 114, H mark reference pattern 122, and V mark reference pattern 124 are transferred to the wafer WF, the position shifts (position shift amounts) of the H mark 112 and V mark 114 are measured using the alignment scope 50. The position shifts (position shift amounts) of the H mark 112 and V mark 114 indicate position shifts from the H mark reference pattern 122 and V mark reference pattern 124 which define ideal positions. The alignment scope 50 is arranged outside the optical axis of the optical system OS to be measured to measure the position shift amount between the H mark 112 and the H mark reference pattern 122 and the position shift amount between the V mark 114 and the V mark reference pattern 124.

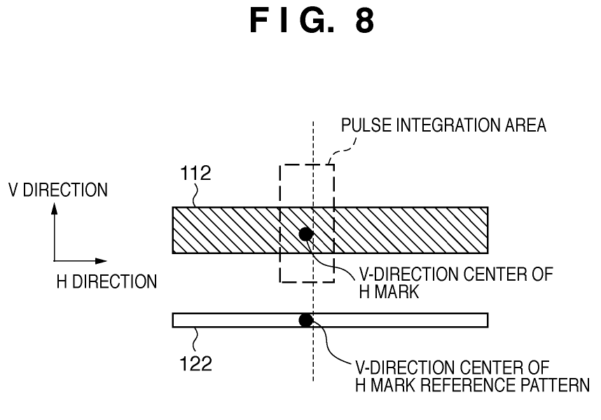

Measurement of the position shift amount between the H mark 112 and the H mark reference pattern 122 will be described in detail with reference to FIG. 8. The longitudinal direction (first direction) of the H mark 112 is defined as an H direction. A direction perpendicular to the H direction, that is, the longitudinal direction (second direction) of the V mark 114 is defined as a V direction. Only the position shift in the V direction, that is, wavefront aberration information in the V direction is measured based on the H mark 112 (and the H mark reference pattern 122). Only the position shift in the H direction, that is, wavefront aberration information in the H direction is measured based on the V mark 114 (and the V mark reference pattern 124). It is possible to obtain the wavefront aberration of the optical system OS to be measured by combining the two pieces of wavefront aberration information obtained based on the H mark 112 and V mark 114.

First, the wafer stage 30 is driven to locate, in the visual field of the alignment scope 50, a point (measurement point) on one element of the H mark 112 to be used to measure the position shift in the V direction and at least one element of the H mark reference pattern 122 near the H mark 112. Next, the H mark 112 is measured in the V direction at the H-coordinate of the desired measurement point, and obtained pulses are integrated (i.e., a pulse integration area is obtained). This makes it possible to obtain the center (V direction) of the H mark 112 at the V-coordinate of the desired measurement point. The same measurement is executed for the H mark reference pattern 122 to obtain the center (V direction) of the H mark reference pattern 122 at the H-coordinate of the desired measurement point. The relative position shift (V direction) between the center of the H mark 112 and the center of the H mark reference pattern 122 is measured, thereby obtaining the position shift (V direction) of the H mark 112 at the desired measurement point. Then, the wafer stage 30 is driven in the H direction by a predetermined driving amount, and the above-described measurement is repeated. The driving amount of the wafer stage 30 at this time preferably matches the pitch of the V mark 114 transferred to the wafer WF. In this way, when measurement of one element of the H mark 112 is ended, the next element of the H mark 112 is measured. This operation is repeated, thereby measuring the position shift of the overall H mark 112.

In this embodiment, the H mark 112 and H mark reference pattern 122 are separately measured. However, they may be measured simultaneously.

Measurement of the position shift amount between the V mark 114 and the V mark reference pattern 124 is the same as the measurement of the position shift amount between the H mark 112 and the H mark reference pattern 122, and a detailed description thereof will be omitted.

After the measurement of the position shift amount of the H mark 112 from its ideal position and the position shift amount of the V mark 114 from its ideal position, the calculation unit 60 executes arithmetic processing of the measurement results to calculate the wavefront aberration of the optical system OS to be measured. More specifically, the measured value obtained from the H mark 112 is the V-direction position shift of each measurement point. The measured value obtained from the V mark 114 is the H-direction position shift of each measurement point. Hence, the H- and V-direction position shifts of each measurement point are obtained from the two measurement results. The wavefront aberration of the optical system OS to be measured is calculated based on the H- and V-direction position shifts of each measurement point. In this way, the calculation unit 60 calculates the wavefront aberration of the optical system OS to be measured based on the position shift amount, from the ideal position, of the wavefront measurement mark 110 (H mark 112 and V mark 114) formed on the image plane of the optical system OS to be measured.

As described above, in this embodiment, a defocus difference (a difference in the defocus amount) is generated between the image of the H mark 112 and the image of the V mark 114 transferred to the wafer WF. The defocus difference results in an astigmatism measurement error (astigmatism error) when calculating the wavefront aberration of the optical system OS to be measured by combining the position shift of the H mark 112 and that of the V mark 114.

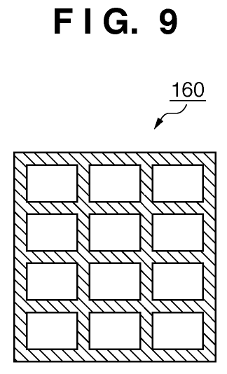

The astigmatism error can be corrected using a grating mark 160 having a lattice shape as shown in FIG. 9. In other words, the grating mark 160 functions as a correction mark which corrects the difference in the defocus amount between the image of the H mark 112 and that of the V mark 114 which are formed on the image plane of the optical system OS to be measured. The grating mark 160 is formed on, for example, the measurement reticle 10.

The grating mark 160 includes a mark (H mark 112) having a longitudinal direction in the H direction (first direction) and a mark (V mark 114) having a longitudinal direction in the V direction (second direction), and therefore, does not generate any defocus difference between the H direction and the V direction in position shift measurement. For this reason, the wavefront aberration of the optical system OS to be measured, which is calculated based on the position shift amount of the grating mark 160, includes no error (astigmatism error) caused by the defocus difference.

The grating mark 160 and a reference mark corresponding to the grating mark 160 are transferred to the wafer WF. The position shift of the grating mark 160 from its ideal position is measured. The wavefront aberration is calculated based on the measurement result. Using the wavefront aberration (wavefront aberration information) calculated based on the grating mark 160 makes it possible to correct the astigmatism error of the wavefront aberration of the optical system OS to be measured, which is calculated based on the position shift of the H mark 112 and that of the V mark 114.

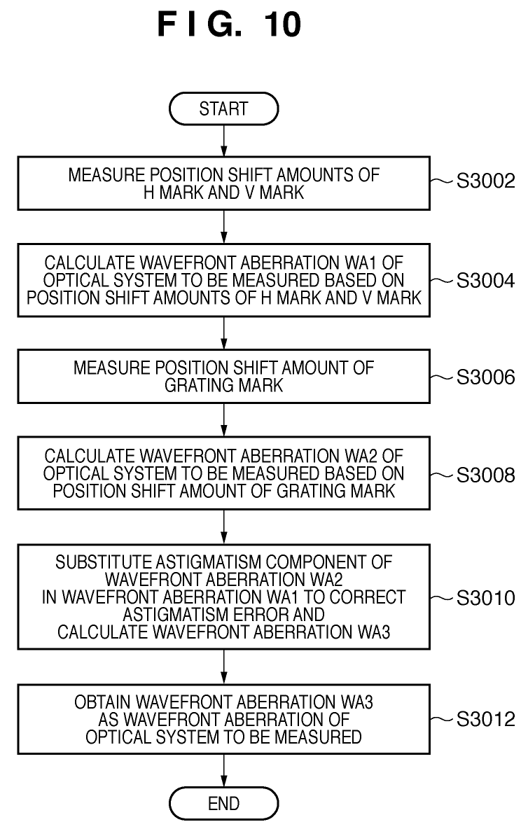

Correction of the astigmatism error of the wavefront aberration of the optical system OS to be measured, which is calculated based on the position shift of the H mark 112 and that of the V mark 114 will be described with reference to FIG. 10. Assume that the H mark 112, the H mark reference pattern 122, the V mark 114, the V mark reference pattern 124, the grating mark 160, and the reference mark corresponding to the grating mark 160 are transferred to the wafer WF.

Referring to FIG. 10, the position shift amount of the H mark 112 and that of the V mark 114 are measured in step S3002.

In step S3004, a wavefront aberration WA1 of the optical system OS to be measured is calculated based on the position shift amount of the H mark 112 and that of the V mark 114 which are measured in step S3002.

In step S3006, the position shift amount of the grating mark 160 is measured.

In step S3008, a wavefront aberration WA2 of the optical system OS to be measured is calculated based on the position shift amount of the grating mark 160 measured in step S3006.

In step S3010, the astigmatism component of the wavefront aberration WA2 is substituted in the wavefront aberration WA1 to correct the astigmatism error included in the wavefront aberration WA1, thereby calculating a wavefront aberration WA3 after astigmatism error correction.

In step S3012, the wavefront aberration WA3 calculated in step S3010 is obtained as the wavefront aberration of the optical system OS to be measured.

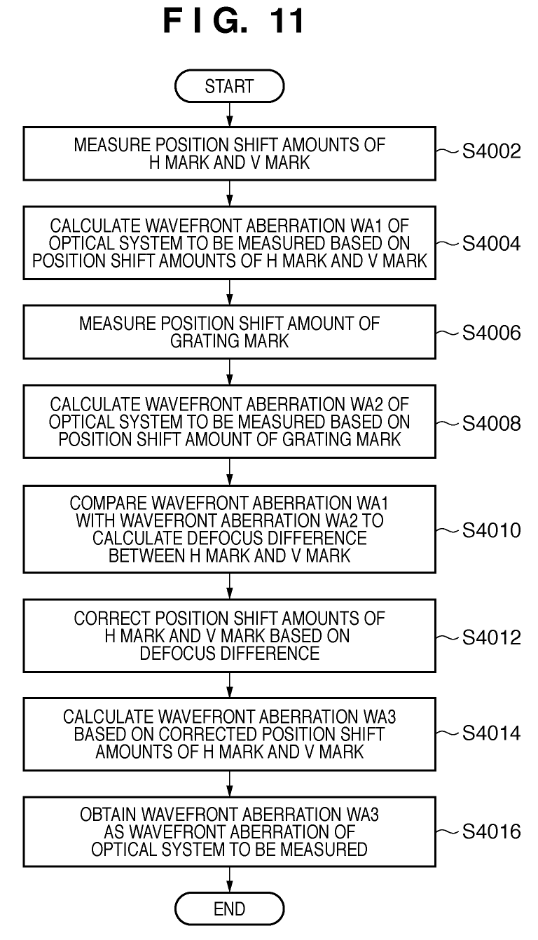

FIG. 11 shows another example of correction of the astigmatism error of the wavefront aberration of the optical system OS to be measured, which is calculated based on the position shift of the H mark 112 and that of the V mark 114. Steps S4002 to S4008 are the same as steps S3002 to S3008 in FIG. 10.

In step S4010, the wavefront aberration WA1 is compared with the wavefront aberration WA2, thereby calculating the defocus difference between the H mark 112 and the V mark 114.

In step S4012, the position shift amounts of the H mark 112 and V mark 114 which are measured in step S4002 are corrected based on the defocus difference calculated in step S4010.

In step S4014, the wavefront aberration WA3 of the optical system OS to be measured is calculated based on the position shift amounts of the H mark 112 and V mark 114 which are corrected in step S4012.

In step S4016, the wavefront aberration WA3 calculated in step S4014 is obtained as the wavefront aberration of the optical system OS to be measured.

A mark having a longitudinal direction in a direction perpendicular to the H direction (first direction) and integrated with the H mark 112, or a mark having a longitudinal direction in the V direction (second direction) and integrated with the V mark 114 may be used as the correction mark.

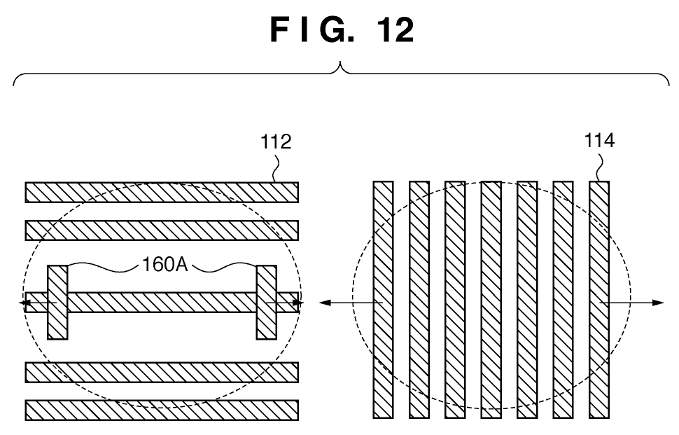

FIG. 12 is a view showing a mark 160A having a longitudinal direction in a direction perpendicular to the H direction and integrated with the H mark 112. The dotted line in FIG. 12 indicates the aperture stop arranged on the pupil plane of the optical system OS to be measured. The mark 160A is formed at two points of the H mark 112, as shown in FIG. 12. The mark 160A is preferably formed to be located at the peripheral portion of the measurement area when being transferred to the wafer WF. In the H mark 112 shown in FIG. 12, the H- and V-direction position shift amounts can be measured at the intersections between the H mark 112 and the mark 160A.

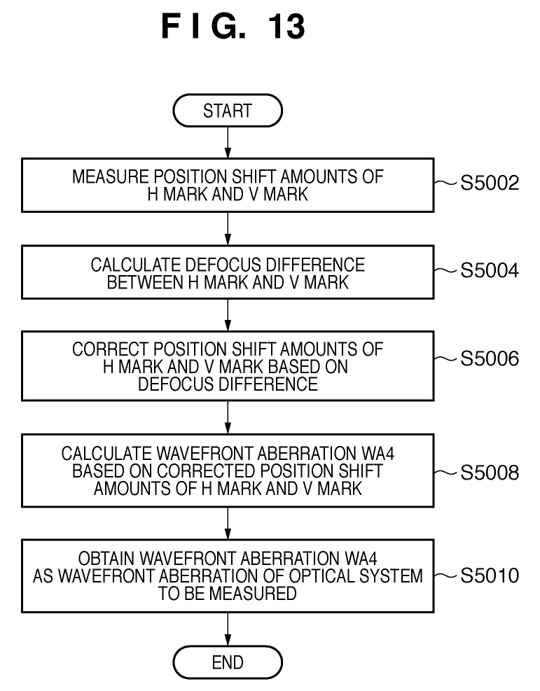

FIG. 13 is a flowchart for explaining correction of the astigmatism error of the wavefront aberration of the optical system OS to be measured, which is calculated based on the position shift of the H mark 112 and that of the V mark 114 when the H mark 112 integrated with the mark 160A is used. Assume that the H mark 112 integrated with the mark 160A, the H mark reference pattern 122, the V mark 114, and the V mark reference pattern 124 are transferred to the wafer WF.

In step S5002, the position shift amount of the H mark 112 integrated with the mark 160A and that of the V mark 114 are measured.

In step S5004, the position shift of the mark 160A is compared with the H-direction position shift (indicated by the arrow in FIG. 12) of the V mark 114 at the same position as the mark 160A, thereby calculating the defocus difference between the H mark 112 and the V mark 114. The defocus difference between the H mark 112 and the V mark 114 can also be calculated by comparing the distance between the elements of the mark 160A integrated with the H mark 112 with the distance between the corresponding elements of the V mark 114.

In step S5006, the position shift amounts of the H mark 112 and V mark 114 which are measured in step S5002 are corrected based on the defocus difference calculated in step S5004.

In step S5008, a wavefront aberration WA4 of the optical system OS to be measured is calculated based on the position shift amounts of the H mark 112 and V mark 114 which are corrected in step S5006.

In step S5010, the wavefront aberration WA4 calculated in step S5008 is obtained as the wavefront aberration of the optical system OS to be measured.

According to the measurement apparatus 1 of this embodiment, it is possible to make the measurement area on the pupil plane of the optical system OS to be measured larger than before and therefore accurately measure the wavefront aberration of the optical system OS to be measured, including higher-order components, using the SPIN method.

In this embodiment, the wavefront measurement mark 110, reference pattern 120, and the like are transferred to the wafer WF. However, an aerial image may be measured using an image sensor without transferring the wavefront measurement mark 110, reference pattern 120, and the like to the wafer WF.

In this embodiment, the alignment scope 50 measures the position shift amounts of the H mark 112 and V mark 114 from their ideal positions. Instead, an overlay measurement apparatus may be used. The position shifts of the H mark 112 and V mark 114 from their ideal positions can also be measured using a reference position on, for example, the wafer stage 30 without using the reference pattern 120.

In this embodiment, the reference pattern 120 is formed on the measurement reticle 10. Instead, the reference pattern 120 may be formed on the reticle stage 20 or another reticle and arranged on the object plane of the optical system OS to be measured.

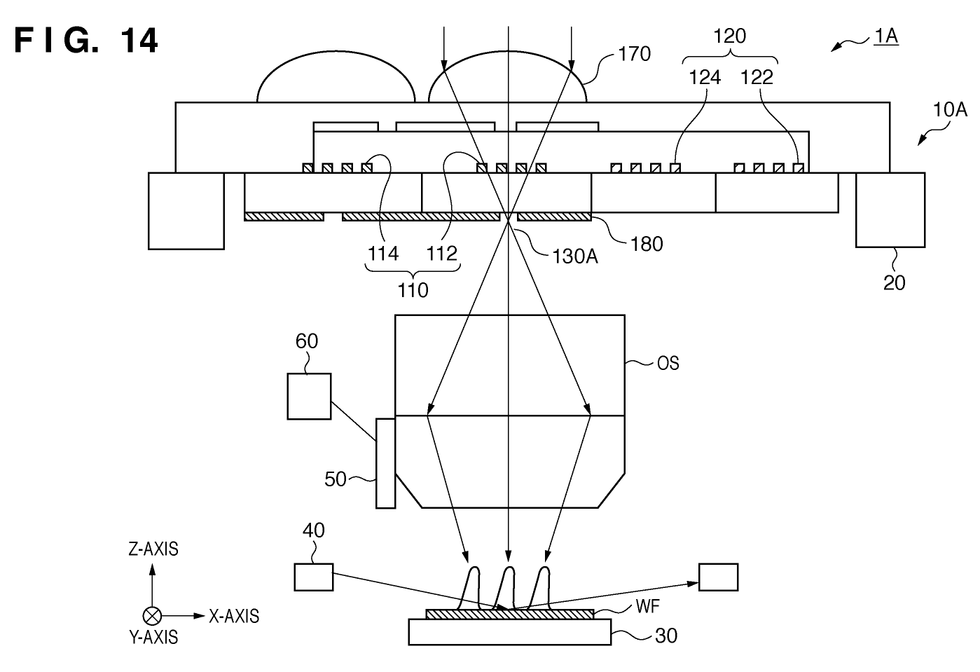

The wavefront measurement mark 110 (HV mark) is also applicable to a measurement apparatus 1A using an ISI method, as shown in FIG. 14. FIG. 14 is a schematic sectional view showing the arrangement of the measurement apparatus 1A according to an aspect of the present invention.

The measurement apparatus 1A measures the wavefront aberration of the optical system OS (e.g., the projection optical system of an exposure apparatus) to be measured using the ISI method. The measurement apparatus 1A includes an illumination system (not shown), a measurement reticle 10A arranged on the object plane of the optical system OS to be measured, the reticle stage 20, the wafer stage 30, the auto-focus system 40, the alignment scope 50, and the calculation unit 60.

The measurement reticle 10A is placed on the reticle stage 20 via a reticle chuck (not shown) and supported to be drivable in the X-, Y-, and Z-axis directions. The measurement reticle 10A has the wavefront measurement mark 110 including the H mark 112 and V mark 114 shown in FIG. 1 on the light exit side.

The measurement reticle 10A also has the reference pattern 120 for the H mark 112 and V mark 114 on the light exit side.

The measurement reticle 10A has a convex lens (positive lens) 170 corresponding to each of the H mark 112 and V mark 114 on the light incident side. The convex lenses 170 are arranged just above the centers of the H mark 112 or V mark 114. The convex lens 170 has a function of illuminating the wavefront measurement mark 110 (H mark 112 and V mark 114) with light at a numerical aperture equal to or larger than that of the optical system OS to be measured such that σ≧1.

A spacer 180 formed from the same frame member as a pellicle frame is arranged just under the wavefront measurement mark 110 and the reference pattern 120. Note that the spacer 180 has pinholes 130A corresponding to the H mark 112 and V mark 114. The spacer 180 has no pinhole but an opening in correspondence with the reference pattern 120. The size of the opening provided in correspondence with the reference pattern 120 is preferably almost equal to the NA of the optical system OS to be measured.

In the measurement apparatus 1A, the wavefront measurement mark 110 (H mark 112 and V mark 114) is obliquely illuminated and transferred to the wafer WF. On the other hand, the reference pattern 120 is not obliquely but normally illuminated and transferred to the wafer WF.

Transfer of the wavefront measurement mark 110 and the reference pattern 120, measurement of the position shift amounts of the H mark 112 and V mark 114, and calculation of the wavefront aberration of the optical system OS to be measured in the measurement apparatus 1A are the same as in the measurement apparatus 1, and a detailed description thereof will be omitted.

According to the measurement apparatus 1A, it is possible to make the measurement area on the pupil plane of the optical system OS to be measured larger than before and therefore accurately measure the wavefront aberration of the optical system OS to be measured, including higher-order components, using the ISI method.

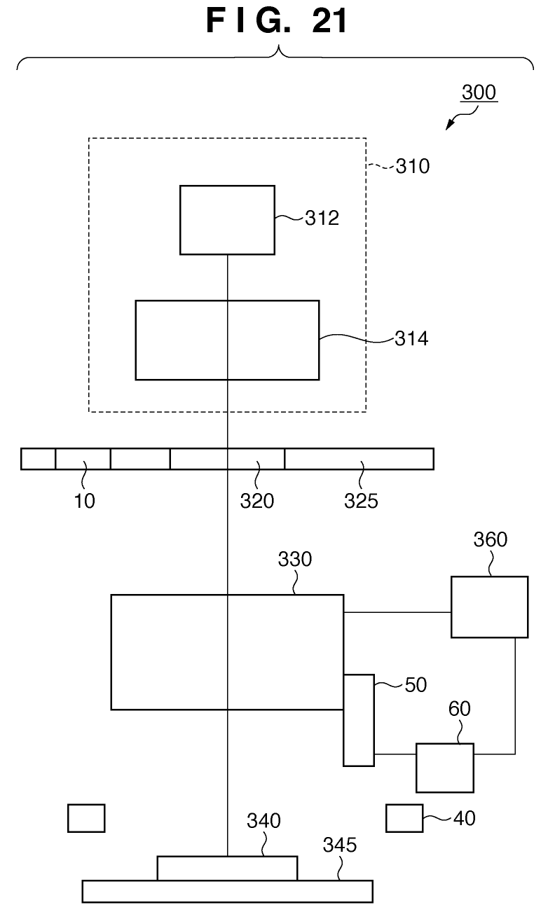

An exposure apparatus having the measurement apparatus 1 or 1A (i.e., having a function of executing the measurement method according to an aspect of the present invention) will be described below. FIG. 21 is a schematic sectional view showing the arrangement of an exposure apparatus 300. The exposure apparatus 300 is a projection exposure apparatus which transfers the pattern of a reticle 320 to a wafer 340 by a step-and-scan method. The exposure apparatus 300 can also use a step-and-repeat method or any other exposure method.

The exposure apparatus 300 includes an illumination apparatus 310, a reticle stage 325 which supports the reticle 320 and the measurement reticle 10, a projection optical system 330, and a wafer stage 345 which supports the wafer 340. The exposure apparatus 300 also includes the auto-focus system 40, the alignment scope 50, the calculation unit 60, and an adjusting unit 360. Note that the illumination apparatus 310, reticle stage 325, wafer stage 345, measurement reticle 10, auto-focus system 40, alignment scope 50, and calculation unit 60 in the exposure apparatus 300 form the above-described measurement apparatus 1. In this embodiment, an example will be described in which the measurement apparatus 1 is applied to the exposure apparatus 300. However, the measurement apparatus 1A is also applicable. To apply the measurement apparatus 1A, the measurement reticle 10 is replaced with the measurement reticle 10A.

The illumination apparatus 310 illuminates the measurement reticle 10 and the reticle 320 on which a circuit pattern to be transferred is formed. The illumination device 310 includes a light source unit 312 and an illumination optical system 314.

The light source unit 312 uses, for example, an excimer laser as a light source. The excimer laser includes a KrF excimer laser having a wavelength of about 248 nm, and an ArF excimer laser having a wavelength of about 193 nm. However, the light source of the light source unit 312 is not limited to the excimer laser. An F2 laser having a wavelength of about 157 nm is also usable.

The illumination optical system 314 illuminates the reticle 320 and the measurement reticle 10. The illumination optical system 314 includes a lens, mirror, optical integrator, phase plate, diffraction optical element, and stop.

The reticle 320 has a circuit pattern and is supported and driven by the reticle stage 325. Diffracted light that has exited from the reticle 320 is projected to the wafer 340 via the projection optical system 330. The exposure apparatus 300 using the step-and-scan method scans the reticle 320 and the wafer 340, thereby transferring the pattern of the reticle 320 to the wafer 340.

The reticle stage 325 supports and drives the reticle 320 and the measurement reticle 10.

The projection optical system 330 projects the pattern of the reticle 320 to the wafer 340. The projection optical system 330 can use a refraction system, catadioptric system, or reflection system. The wavefront aberration of the projection optical system 330, including higher-order components, is accurately adjusted, as will be described later.

In this embodiment, the wafer 340 is a substrate on which the pattern of the reticle 320 is projected (transferred). However, the wafer 340 may be replaced with a glass plate or another substrate. A photoresist is applied to the wafer 340.

The wafer stage 345 supports and drives the wafer 340.

The adjusting unit 360 adjusts the projection optical system 330 based on the measurement result of the measurement apparatus 1 (i.e., the wavefront aberration of the projection optical system 330 calculated by the calculation unit 60) to reduce the wavefront aberration.

In the operation of the exposure apparatus 300, first, the wavefront aberration of the projection optical system 330 is measured. The wavefront aberration of the projection optical system 330 is measured using the illumination apparatus 310, reticle stage 325, wafer stage 345, measurement reticle 10, auto-focus system 40, alignment scope 50, and calculation unit 60 included in the measurement apparatus 1, as described above. After measurement of the wavefront aberration of the projection optical system 330, the adjusting unit 360 adjusts the projection optical system 330 based on the measurement result. Since the measurement apparatus 1 can accurately measure the wavefront aberration of the projection optical system 330, including higher-order components, as described above, the adjusting unit 360 accurately adjusts the wavefront aberration of the projection optical system 330.

Next, the pattern of the reticle 320 is exposed to the wafer 340. A light beam emitted from the light source unit 312 illuminates the reticle 320 via the illumination optical system 314. The light that reflects the pattern of the reticle 320 forms an image on the wafer 340 via the projection optical system 330. The projection optical system 330 used in the exposure apparatus 300 has an excellent imaging capability because the wavefront aberration is accurately adjusted, as described above. Hence, the exposure apparatus 300 can provide a high-quality device (e.g., semiconductor integrated circuit element or liquid crystal display element) economically at a high throughput. Note that the device is manufactured by the step of causing the above-described exposure apparatus to expose a circuit pattern to a substrate (e.g., wafer or glass plate) applied with a photoresist, the step of developing the exposed substrate, and other known steps.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-040451 on Feb. 21, 2008, which is hereby incorporated by reference herein in its entirety.

What is claimed is:

1. A measurement method of measuring a wavefront aberration of an optical system to be measured using a measurement reticle including a wavefront measurement mark and a pinhole to make light from the wavefront measurement mark impinge on different positions on a pupil plane of the optical system to be measured, the method comprising:
arranging the measurement reticle on an object plane of the optical system to be measured;
forming an image of the wavefront measurement mark on an image plane of the optical system to be measured; and
calculating the wavefront aberration of the optical system to be measured based on a position shift amount of the image of the wavefront measurement mark from an ideal position, the image being formed on the image plane of the optical system to be measured,
wherein the wavefront measurement mark includes a first mark having a longitudinal direction in a first direction, and a second mark having a longitudinal direction in a second direction perpendicular to the first direction and spaced apart from the first mark.

2. The method according to claim 1, wherein the wavefront measurement mark and the pinhole are arranged to make light which has passed through the pinhole impinge on the wavefront measurement mark, and
the measurement reticle further includes a diffusing part to illuminate the wavefront measurement mark with illumination light at a numerical aperture larger than a numerical aperture of the optical system to be measured.

3. The method according to claim 1, wherein
the wavefront measurement mark and the pinhole are arranged to make light which has passed through the wavefront measurement mark impinge on the pinhole, and
the measurement reticle further includes a lens to illuminate the wavefront measurement mark with illumination light at a numerical aperture larger than a numerical aperture of the optical system to be measured.

4. The method according to claim 1, further comprising arranging a correction mark to correct a difference in a defocus amount between an image of the first mark and an image of the second mark, which are formed on the image plane of the optical system to be measured, and forming an image of the correction mark on the image plane of the optical system to be measured, and
wherein in the calculation step, the wavefront aberration of the optical system to be measured is calculated based on position shift amounts of the image of the first mark and the image of the second mark from ideal positions and a position shift amount of the image of the correction mark from an ideal position, the images being formed on the image plane of the optical system to be measured.

5. The method according to claim 4, wherein the correction mark includes a grating mark having a lattice shape.

6. The method according to claim 4, wherein the correction mark is integrated with at least one of the first mark and the second mark.

7. The method according to claim 6, wherein the correction mark includes one of a mark which is perpendicular to the first mark and a mark which is perpendicular to the second mark.

8. The method according to claim 1, wherein the formation step includes:
arranging one mark of the first mark and the second mark at a predetermined position on the object plane of the optical system to be measured and forming an image of the one mark; and
arranging the other mark of the first mark and the second mark at the predetermined position on the object plane of the optical system to be measured and forming an image of the other mark.

9. The method according to claim 1, wherein the optical system to be measured is a projection optical system which projects a pattern of a reticle to a substrate.

10. A measurement reticle arranged on an object plane of an optical system to be measured when measuring a wavefront aberration of the optical system to be measured, comprising:
a wavefront measurement mark; and
a pinhole to make light from the wavefront measurement mark impinge on different positions on a pupil plane of the optical system to be measured,
the wavefront measurement mark including a first mark having a longitudinal direction in a first direction, and a second mark having a longitudinal direction in a second direction perpendicular to the first direction and spaced apart from the first mark.
